(19) United States
(12) Patent Application Publication
(10) Pub. No.: US 2005/0091456 A1
(43) Pub. Date: Apr. 28, 2005

(54) Determining an arrangement of data in a memory for cache efficiency

(76) Inventor: Jerome C. Huck, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/692,061

(22) Filed: Oct. 23, 2003

(51) Int. Cl. G06F 12/00

(52) U.S. Cl. 711/118; 711/170

(57) ABSTRACT

There is provided a cache that includes a cache line, and an indicator associated with a unit-sized portion of the cache line. The indicator indicates whether the unit-sized portion is accessed. A method for determining an arrangement of data in a memory for efficient operation of a cache includes determining whether the unit of the data is accessed during an execution of code, and compiling the code to place the unit in a line of the memory if the unit is accessed during the execution. The line of the memory is designated to contain, in contiguous locations, a plurality of units of the data that are accessed during the execution.

### BACKGROUND OF THE INVENTION

1. Field of the Invention

The present disclosure relates to a computer system, and more particularly, to a specialized cache memory that is used to determine a layout of memory for an application program. The layout of the memory facilitates an efficient operation of a cache memory when the application is subsequently executed.

2. Description of the Prior Art

In a conventional computer system, a processor or central processing unit (“CPU”) reads data and instructions, sometimes collectively referred to herein as “data”, from a main memory in order to execute a computer program. From the perspective of the CPU, the time required to access the main memory and to retrieve data needed by the CPU is relatively long. Valuable time may be lost while the CPU waits on data being fetched from main memory.

A cache memory is a special memory that is intended to supply a processor with most frequently requested data. Cache memory is implemented with a relatively high speed memory component as compared to that of main memory, and is interposed between the relatively slower main memory and the CPU to improve effective memory access rates. Data located in cache memory can be accessed many times faster than data located in main memory. The more data the CPU can access directly from cache memory, the faster a computer will operate. Cache memory serves as a buffer between the CPU and main memory, and is not ordinarily user addressable. The user is only aware of an apparently higher-speed main memory. The use of cache memory improves overall system performance and processing speed of the CPU by decreasing the apparent amount of time required to fetch data from main memory.

Cache memory is generally smaller than main memory because cache memory employs relatively expensive high-speed memory devices such as a static random access memory (SRAM). As such, cache memory is generally not large enough to hold all of the data needed during execution of a program, and most data is only temporarily stored in cache memory during program execution. Thus, cache memory is a limited resource that designers of computer systems wish to utilize in an efficient a manner.

When the CPU needs to obtain data, the system determines whether the data is currently stored in cache memory, and if so, the data may be quickly retrieved therefrom. When cache memory is full, and new data is necessary for processing, data in the cache must be replaced or “overwritten” with the new data from main memory. The minimum unit of data that can be either present or not present in a cache memory is referred to as a “memory block”.

A “cache hit” is a situation where data, at the time it is being sought, is located in the cache memory. A cache hit yields a significant saving in program execution time. When the data being is sought is not contemporaneously located in cache memory, a “cache miss” occurs. A cache miss requires that the desired data be retrieved, in a relatively slow manner, from main memory and then placed in cache memory.

Data is stored in the cache based on what data the CPU is likely to need for or during execution of a next instruction. In addition to obtaining the data from the main memory, the desired data and data surrounding the desired data are copied from the main memory and stored in the cache. Typically, data surrounding the desired data is stored in the cache because there is a statistical likelihood that the CPU will need the surrounding data next. If the surrounding data is subsequently needed, it will be available for fast access in the cache memory.

Several factors contribute to the optimal utilization of cache memory in computer systems. These factors include, for example, (a) cache memory hit ratio, i.e., a probability of finding a requested item in cache, (b) cache memory access time, (c) delay incurred due to a cache memory miss, and (d) time required to synchronize main memory with cache memory, i.e., store-through. The computer engineering community has endeavored to develop techniques that are intended to improve cache memory utilization and efficiency.

A cache memory updating and replacement scheme is a technique that attempts to maximize the number of cache hits, and to minimize the number of cache misses. One such technique is described in U.S. Pat. No. 5,568,632 to Nelson (“the '632 patent”). The '632 patent is specifically directed toward a type of cache memory known as a “set associative” cache memory. A cache memory is said to be “set associative” if a block can only be placed in a restrictive set of places in the cache memory, namely, in a specified “set” of the cache memory. The '632 patent describes, for a set associative cache memory having memory blocks of data that are organized into sets and columns, a technique for selecting a column of cache memory for replacement of the memory block data contained therein. The technique involves assigning indices to the memory blocks of a given set of the cache memory, randomly selecting an indice, and replacing the memory block of the given set to which the selected indice is assigned. The indices are assigned such that one or more blocks of the given set have a high probability of replacement.

Data stored in the cache is usually packaged in groups of bytes that are integer multiples of the processor bandwidth and a cache line capacity. However, some processors allow variable length data packages to be processed. In the case of variable length data packages, the data may not be an integer multiple of the cache line capacity. For example, one instruction that is comprised of multiple bytes may begin on one cache line and end on the next sequential cache line. This is referred to as data that crosses a cache line.

U.S. Pat. No. 6,226,707 to Mattela et al. (“the '707 patent”) describes a system and method for arranging and accessing information that crosses cache lines. The method in the '707 patent utilizes dual cache columns that are formed of two access-related cache lines. The two cache columns contain sequential information that is stored in cache lines in a sequential and alternating format. A processor makes a request for a particular instruction, and an instruction fetch unit takes the instruction request and creates a second instruction request in addition to the first instruction request. The two instruction requests are sent simultaneously to first and second content addressable memories respectively associated with the first and second cache columns. The content addressable memories are simultaneously searched and any cache hits are forwarded to a switch. The switch combines the relevant portions of the two cache lines and delivers the desired instruction to a processor.

Both of the '632 patent and the '707 patent are directed toward techniques for actively manipulating the data in the cache during actual execution of a program that utilizes the data. Another type of strategy for improving cache efficiency is one that is directed toward an arrangement or layout of data for optimizing cache operation.

U.S. Pat. No. 6,324,629 to Kulkarni et al. (“the '629 patent”) describes a method of determining an optimized data organization in a memory of a system with a cache for the memory, the optimized data organization being characteristic for an application to be executed by the system. The method includes loading a representation of the application, partitioning an array into a plurality of subarrays, and distributing the subarrays over the memory such that an optimal performance of the cache is obtained.

Another technique that attempts to optimize cache performance involves a training session during which a program is evaluated in terms of a utilization of instructions or procedures in the program. Based on the utilization of the instructions or procedures, data in memory is organized to facilitate the cache operation. For example, a procedure-based training session determines how often a procedure is entered so that the procedure can be appropriately located in the memory based on the utilization of the procedure.

The aforementioned patents and techniques operate on, and locate, one or more lines of data from a main memory into a cache memory as a cache line, in a sequence or at a time that is deemed to optimize cache performance. Thus, the cache line is managed as a unit.

Although a processor may need to access only a portion of a line of data, the full line of data must nevertheless be transferred from main memory. Such a situation is known as fragmentation of data. Fragmentation of data contributes to cache inefficiency and is a problem associated with the management of a cache line as a unit.

### SUMMARY OF THE INVENTION

One embodiment of the present invention is a cache. The cache includes a cache line, and an indicator associated with a unit-sized portion of the cache line. The indicator indicates whether the unit-sized portion is accessed.

The present invention also provides a method for determining an arrangement of data in a memory for efficient operation of a cache. The method includes (a) determining whether a unit of the data is accessed during an execution of code, and (b) compiling the code to place the unit in a line of the memory if the unit is accessed during the execution. The line of the memory is designated to contain, in contiguous locations, a plurality of units of the data that are accessed during the execution.

Another embodiment of a method for determining an arrangement of data in a memory for efficient operation of a cache includes (a) determining whether a unit of the data is likely to be accessed during an execution of code, and (b) compiling the code to place the unit in a line of the memory if the unit is likely to be accessed during the execution. The line of the memory is designated to contain, in contiguous locations, a plurality of units of the data that are likely to be accessed during the execution.

Yet another method for determining an arrangement of data in a memory for efficient operation of a cache includes (a) executing code during a training session, (b) determining whether a byte of the data is accessed during the training session, and (c) compiling the code to place the byte in a line of the memory if the byte is accessed during the training session. The action of determining evaluates an indicator that is associated with a byte-sized portion of a line of the cache into which the byte is cached. The indicator indicates whether the byte is accessed during the training session, and the line of the memory is designated to contain, in contiguous locations, a plurality of bytes of the data that are accessed during the training session.

### BRIEF DESCRIPTION OF THE DRAWINGS

FIG. 1 is a block diagram of a computer system.

FIG. 2 is a flow diagram of a method for determining an arrangement of data in a memory for efficient operation of a cache.

FIG. 3 is a flowchart of a training session, which forms a part of the method illustrated in FIG. 2.

FIG. 4 illustrates an exemplary arrangement of data in a main memory after reorganization.

### DESCRIPTION OF THE INVENTION

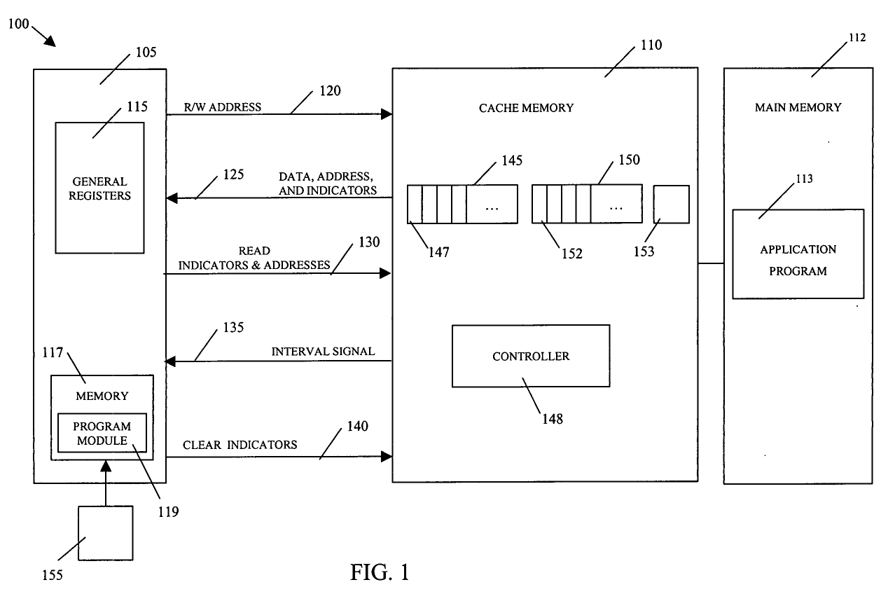

FIG. 1 is a block diagram of a computer system 100. The principal components of system 100 are a CPU 105, a cache memory 110, and a main memory 112.

Main memory 112 is a conventional main memory component into which is stored an application program 113. For example, main memory 112 can be any of a disk drive, a compact disk, a magnetic tape, a read only memory, or an optical storage media. Although shown as a single device in FIG. 1, main memory 112 may be configured as a distributed memory across a plurality of memory platforms. Main memory 112 may also include buffers or interfaces that are not represented in FIG. 1.

CPU 105 is processor, such as, for example, a general-purpose microcomputer or a reduced instruction set computer (RISC) processor. CPU 105 may be implemented in hardware or firmware, or a combination thereof. CPU 105 includes general registers 115 and an associated memory 117 that may be installed internal to CPU 105, as shown in FIG. 1, or external to CPU 105.

Memory 117 contains a program module 119 of instructions and data for controlling processor 105 to perform a method for determining an arrangement of data in a memory for efficient operation of a cache, as described herein. Program module 119 may be configured as a plurality of sub-modules, subroutines or functional units, and includes a “training program”, the execution of which allows CPU 105 to monitor and evaluate the behavior of application program 113. More particularly, during execution of the training program, CPU 105 also executes application program 113 so that CPU 105 can determine whether a particular unit of data in main memory 112 is accessed during the execution of application program 113. The operation of the training program is described below in greater detail.

Although system 100 is described as having program module 119 installed into memory 117, program module 119 can reside on an external storage media 155 for subsequent loading into memory 117. Storage media 155 can be any conventional storage media, including, but not limited to, a floppy disk, a compact disk, a magnetic tape, a read only memory, or an optical storage media. Storage media 155 could also be a random access memory, or other type of electronic storage, located on a remote storage system and coupled to memory 117.

Cache memory 110 is interposed between CPU 105 and main memory 112 for caching data that CPU 105 needs to access, i.e., either read from or write to, in main memory 112. Cache memory 100 includes a cache line 145 into which a line of data from main memory 112 is cached if the line of data needs to be accessed by CPU 105. For example, if CPU executes application program 113, a line of instructions and data from application program 113 will be copied from main memory 112 into cache line 145. In a practical implementation, cache memory 110 may include a plurality of cache lines 145. Although it is not imperative, cache memory 110 is contemplated as being substantially smaller in memory size than main memory 112.

Cache line 145 is composed of a plurality unit sized portions, preferably bytes, one of which is represented in FIG. 1 as byte 147. Cache line 145 is augmented with a set of indicators 150, one of which is represented in FIG. 1 as indicator 152. There is one indicator 152 for each byte 147 of cache line 145. Cache line 145 has an associated address field 153 that contains a representation of the address to which cache line 145 corresponds in main memory 112. Thus, address field 153 identifies the address in main memory 112 to which indicators 150 correspond. Address field 153 is also used as part of a normal cache operation to determine a “hit” or “miss”, i.e., whether the address of main memory 112 that is being accessed is in cache memory 110, also referred to as a “tag”.

Cache memory 110 includes a controller 148 that oversees various operations relating to cache line 145, indicators 150, e.g., initializing and setting indicators 150. In practice, controller 148 can be conveniently implemented as an electronic circuit in either hardware or firmware.

Indicator 152 indicates whether byte 147 is accessed. More specifically, if a line of data from main memory 112 is cached into cache line 145, and byte 147 is accessed, indicator 152 indicates that the access occurred. Indicator 152 may be implemented as a single bit, the state of which indicates whether the access occurred, e.g., yes or no. Alternatively, indicator 152 may be implemented as a multi-state field for indicating a plurality of conditions such as, (a) whether the access occurred, (b) a number of times that the access occurred, and (c) a frequency or rate of access.

Several signals are exchanged between CPU 105 and cache memory 110, namely (a) R/W address signal 120, (b) data, address and indicators signals 125, (c) read indicators and addresses signal 130, (d) interval signal 135, and (e) clear indicators signal 140. These signals can be communicated between CPU 105 and cache memory 110 on discrete lines or via a general-purpose bus. Any suitable cabling configuration, either parallel or serial, may be employed.

R/W address signal 120 is directed from CPU 120 to cache memory 110. Via this signal, CPU 105 provides an address of data that CPU 105 wishes to access.

Data, address and indicators signals 125 are directed from cache memory 110 to CPU 105. These signals collectively represent various data, addresses and indicators that cache memory 110 sends to CPU 105. The “indicators” are from indicators 150, and the “addresses” are from address field 153.

Assume that CPU 105 wishes to read some data from main memory 112. CPU 105 sends the address of the data to cache 110 via R/W address signal 120. If the data is not previously cached, that is, if the data is not presently resident in cache memory 110, then cache memory 110 retrieves the data from main memory 112 and thereafter sends the data to CPU 105 via data, address and indicators signals 125. If the data is previously cached, and for example assume that the subject data is presently cached at byte 147, then cache sends the data from byte 147 to CPU 105.

Read indicators and addresses signal 130 is a command directed from CPU 105 to cache memory 110. CPU 105 sends this command when it wishes to read indicators 150 and address field 153. In response to this command, cache memory 110 sends indicators 150 and address field 153 to CPU 105 via data, address and indicators signal 125.

Interval signal 135 is directed from cache memory 110 to CPU 105. This signal indicates to CPU 105 that some event has occurred or some interval of time has lapsed. Interval signal 135 is described below in greater detail.

Clear indicators signal 140 is a command directed from CPU 105 to cache memory 110. CPU 105 sends this command when it wishes for cache memory 110 to clear indicators 150. Clear indicators signal 140 can be structured to cause cache memory 110 to clear all of indicators 150, or to clear certain selected indicators 150.

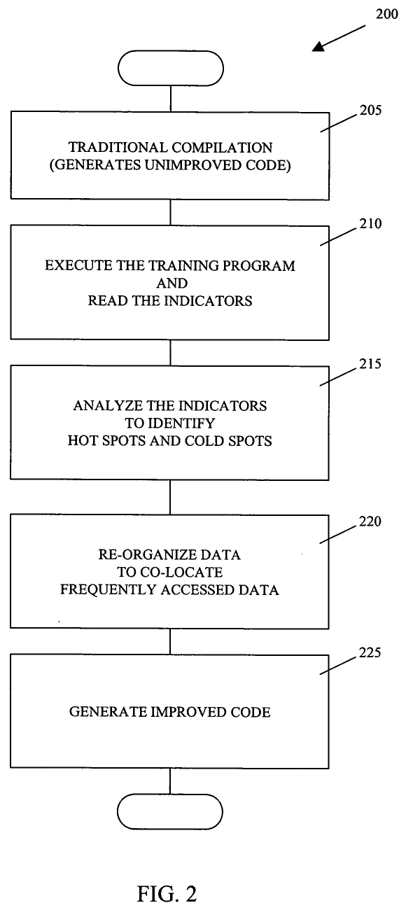

FIG. 2 is a flow diagram of a method 200 for determining an arrangement of data in a memory for efficient operation of a cache. Method 200 is described below with reference to the operation of system 100, shown in FIG. 1. Method 200 begins with step 205.

In step 205, CPU 105 compiles application program 113. This compilation is a traditional compilation as is well known in the art. The compilation yields a layout of instructions and data for application program 113 in main memory 112. This layout is referred to herein as “unimproved code.” Method 200 then progresses to step 210.

In step 210, CPU 105 executes the training program, which as mentioned earlier resides in program module 119. The training program defines a training session during which CPU 105 also executes application program 113. During its execution of application program 113, CPU 105 accesses data from main memory 112. The accessed data, and more specifically a line of main memory 112 within which the data is located, is moved into cache line 145, and cache memory 110, in turn, sends the data to CPU 105.

Assume for example that the accessed data is located in byte 147. Controller 148 sets indicator 152 to indicate that byte 147 is accessed. If the accessed data spans across multiple bytes, then controller 148 sets other indicators 150 that correspond to the accessed bytes.

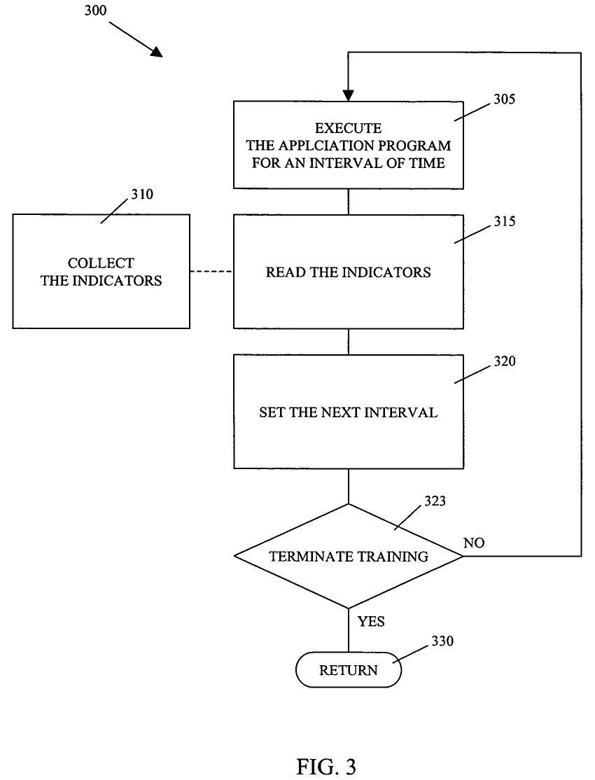

After the training session, or a suitable portion thereof, is completed, CPU 105 reads indicators 150 from cache memory 110. As mentioned earlier, to read indicators 150, CPU 105 sends a read indicators and addresses signal 130 to cache memory 110, and in response, cache memory 110, and more specifically controller 148, sends indicators 150 and address field 153 to CPU 105 via data, address and indicators signals 125. Step 210 is described in greater detail below, in association with FIG. 3. Method 200 then progresses to step 215.

In step 215, CPU 105 evaluates indicators 150 and address field 153, and determines whether a particular unit of data is accessed during the execution of application program 113. In practice, CPU 105 considers a full extent of the data associated with application program 113 and determines which bytes of the full extent of the data are accessed. Thus, CPU 105 analyzes indicators 150 to identify “hot spots” and “cold spots” within main memory 112.

In a preferred embodiment of steps 210 and 215, CPU 105 determines whether a byte of data is likely to be accessed during an execution of application program 113. For example, if a first byte of data is accessed only once during the training session, and a second byte of data is accessed one hundred times during the training session, the first byte of data, although accessed, is not necessarily likely to be accessed, whereas the second byte is more likely to be accessed.

One technique for determining whether a byte of data is likely to be accessed is to repeat the operation of step 210 one or more times. More specifically, after the first execution of step 210, CPU 105 issues clear indicators signal 140 to initialize indicators 150, and then continues the training session for an interval of time. CPU 105 executes application program 113, repeats its evaluation of indicators 150, and determines an average rate of access of byte 147 during the training session.

As a further enhancement of method 200, CPU 105 can determine a statistical ranking of a usage of a byte of data with respect to a usage of other bytes of the data during the training session. For example, if indicators 150 are implemented to show a total number of times that a byte of data is accessed, then CPU 105 can rank all of the accessed bytes in an order of most used to least used.

Thus, by determining whether a byte of data is accessed during execution of application program 113 during the training session, CPU 105 can determine whether the byte is likely to be accessed during a subsequent execution of application program 113. After completion of step 215, method 200 progresses to step 220.

In step 220, CPU 105 re-organizes main memory 112 to co-locate frequently accessed data. For example, bytes of data that are identified as having been accessed are assigned to a line of main memory 112, and more specifically, assigned to contiguous locations, i.e., contiguous addresses, of the line of main memory 112.

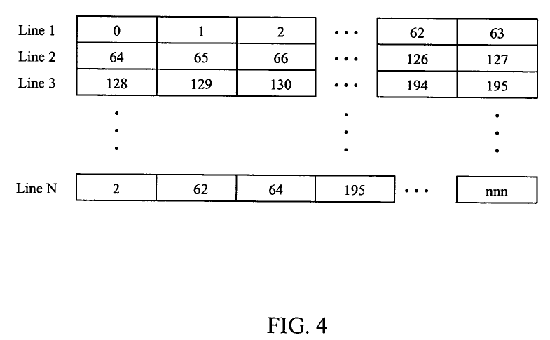

FIG. 4 illustrates an exemplary arrangement of data in main memory 112 after step 220 has re-organized the data. FIG. 4 shows four lines of main memory 112, namely lines 1, 2 3 and N, each of which is 64 bytes in length. For example, assume that during the training session, bytes 2, 62, 64 and 195 are accessed. As such, in step 220, CPU 105 assigns bytes 2, 62, 64 and 195 to line N of main memory 112.

Line N is designated to contain, in contiguous locations, a plurality of bytes of data that are accessed, or in the preferred embodiment likely to be accessed, during a subsequent execution of application program 113. If any data in line N is accessed during a subsequent execution of the application program 113, then line N is cached. Advantageously, when line N is cached for the benefit of one byte of data, the other data in line N, which were accessed, or are likely to be accessed, are also cached.

Referring again to FIG. 2, after completion of step 220, method 200 progresses to step 225.

In step 225, CPU 105 compiles application program 113 to yield an “improved” version thereof. Note that this is a re-compilation of application program 113, that is, in addition to the compilation performed in step 205. With the compilation in step 225, data in main memory 112 is organized as determined in step 220. In particular, main memory 112 is re-organized as described earlier in association with FIG. 4 such that frequently accessed data are located in contiguous address of a line of main memory 112.

FIG. 3 is a flowchart of a training session 300, which forms a part of step 210, as described earlier. Training session 300 begins with step 305.

In step 305, CPU 105 executes application program 113 for a training interval. From a practical point of view, CPU 305 should initialize indicators 150 prior to the execution of application program 113. However, the point at which such initialization is actually performed can be left to the discretion of a designer of the training session.

The training interval can be an interval of time, but it does not necessarily need to be a fixed period of time. The time intervals may, do not need to, be run contiguously in time. For example, the interval may run for a few milliseconds per second. Also, instead of being delimited by time, the training interval can be a function of an event relating to the operation of cache memory 110. Such an event could be, for example, (a) an occurrence of a number of cache misses exceeds a predetermined threshold, or (b) a number of indicators 150 showing a number of bytes accessed exceeds a predetermined threshold, and thus there has been a suitable level of change in the collective state of the indicators to warrant a re-organization of main memory 112. The occurrence of the event is communicated from cache memory 110 to CPU 105 via interval signal 135. After completion of step 305, training session 300 progresses to step 315.

In step 315, CPU 105 reads indicators 150 to determine which bytes of cache line 145, and thus which bytes of main memory 112, have been accessed. As mentioned earlier, in a practical implementation, cache memory 110 would include a plurality of cache lines 145. As such, CPU 105 would determine which bytes where accessed throughout the plurality of cache lines.

Contemporaneously, in step 310, CPU 105 collects and stores information relating to the state of the indicators. For example, CPU 105 can collect information concerning whether a byte of data is accessed, an average rate of access for the byte, and a statistical ranking of the usage of the byte. Training session 300 then progresses to step 320.

In step 320, CPU 105 sets up a next training interval. Such a set up would include, for example, sending clear indicators signal 140 to cache memory 110 in order to clear one or more of indicators 150. Training session 300 then progresses to step 323.

In step 323, CPU 105 determines whether to terminate training session 300. If training session is not yet to be terminated, then it loops back to step 305. If training session 300 is to be terminated, then it advances to step 330. The decision to terminate can be based on any suitable criterion, such as performing training session 300 in loop for a predetermined number of times, or operating for a predetermined period of time.

In step 330, training session 300 is terminated.

Cache memory 110 includes a mechanism, i.e., indicators 150, to record which bytes in cache line 145 are accessed and written. For example, a 64-byte cache line is augmented with 64 bits, e.g., indicator 152, that indicate the exact bytes, e.g., byte 147, that have been accessed since a time that a line of main memory 112 is moved into cache memory 110. After every cache access, indicators 150 are updated to reflect the accesses.

At some interval, e.g., a periodic interval, a software program, program module 119, reads indicators 150 and address field 153 to determine which bytes 147 were accessed. Using this information, program module 119 controls CPU 105 to reorganize the layout of data in main memory 112 address space so as to place data that is identified as having been accessed together with other data that has been accessed. Similarly, data that is not accessed, or that is infrequently accessed, is grouped with other infrequently accessed data.

By grouping frequently accessed information together, cache lines 145 are more effectively utilized. For example, if only 16 bytes in each of four 64-byte cache lines are accessed, then it would be more effective to put those four 16-byte elements into a single 64-byte line and the remainder of the data in the other three lines. Theoretically, the frequently accessed data would most likely be in the cache when the data is needed, and the three lines of infrequently accessed data would only be brought in on the rare occasions that it is needed. This improves cache effectiveness by allowing the most important data to be located in the cache.

It should be understood that various alternatives, combinations, and modifications of the teachings described herein could be devised by those skilled in the art. The present invention is intended to embrace all such alternatives, combinations, modifications and variances that fall within the scope of the appended claims.

1. A cache comprising:
a cache line; and
an indicator associated with a unit-sized portion of said cache line,
wherein said indicator indicates whether said unit-sized portion is accessed.

2. The cache of claim 1, wherein said unit-sized portion is a byte.

3. The cache of claim 1, wherein said indicator further indicates a number of times that said unit-sized portion is accessed.

4. The cache of claim 1, wherein said cache is employed in a system comprising a processor for:
executing code;
evaluating said indicator, wherein said indicator indicates whether a unit of data in a memory is accessed during said execution; and
compiling said code to place said unit in a line of said memory if said unit is accessed during said execution,
wherein said line of said memory is designated to contain, in contiguous locations, a plurality of units of said data that are accessed during said execution.

5. The cache of claim 1, wherein said cache is employed in a system comprising a processor for:
determining whether a unit of data in a memory is likely to be accessed during an execution of code; and
compiling said code to place said unit in a line of said memory if said unit is likely to be accessed during said execution,
wherein said line of said memory is designated to contain, in contiguous locations, a plurality of units of said data that are likely to be accessed during said execution.

6. The cache of claim 5, wherein said determining comprises:
executing said code in a training session; and
evaluating said indicator to determine whether said unit is accessed during said training session.

7. The cache of claim 6, wherein said determining further comprises:
initializing said indicator;
repeating said evaluating after continuing said training session for an interval of time; and
determining an average rate of access of said unit during said training session.

8. The cache of claim 6, wherein said determining further comprises:
initializing said indicator;
repeating said evaluating after continuing said training session for an interval of time; and
determining a statistical ranking of a usage of said unit with respect to a usage of other units of said data during said training session.

9. The cache of claim 1,
wherein said unit-sized portion is a byte, and
wherein said cache is employed in a system comprising a processor for:
executing code in a training session;
evaluating said indicator, wherein said indicator indicates whether a byte of data in a memory is accessed during said training session; and
compiling said code to place said byte in a line of said memory if said byte is accessed during said training session,
wherein said line of said memory is designated to contain, in contiguous locations, a plurality of bytes of said data that are accessed during said training session.

10. A method for determining an arrangement of data in a memory for efficient operation of a cache, said method comprising:
determining whether a unit of said data is accessed during an execution of code; and
compiling said code to place said unit in a line of said memory if said unit is accessed during said execution,
wherein said line of said memory is designated to contain, in contiguous locations, a plurality of units of said data that are accessed during said execution.

11. The method of claim 10, wherein said unit is a byte-sized portion of said data.

12. The method of claim 10, wherein said determining comprises:
executing said code in a training session;
evaluating an indicator that is associated with a unit-sized portion of a line of said cache into which said unit is cached,
wherein said indicator indicates whether said unit is accessed during said training session.

13. A method for determining an arrangement of data in a memory for efficient operation of a cache, said method comprising:
determining whether a unit of said data is likely to be accessed during an execution of code; and
compiling said code to place said unit in a line of said memory if said unit is likely to be accessed during said execution,
wherein said line of said memory is designated to contain, in contiguous locations, a plurality of units of said data that are likely to be accessed during said execution.

14. The method of claim 13, wherein said unit is a byte-sized portion of said data.

15. The method of claim 13, wherein said determining comprises:
executing said code during a training session;
evaluating an indicator that is associated with a unit-sized portion of a line of said cache into which said unit is cached during said training session,
wherein said indicator indicates whether said unit is accessed during said training session.

16. The method of claim 15, wherein said determining further comprises:
initializing said indicator;
repeating said evaluating after continuing said training session for an interval of time; and
determining an average rate of access of said unit during said training session.

17. The method of claim 15, wherein said determining further comprises:
initializing said indicator;
repeating said evaluating after continuing said training session for an interval of time; and
determining a statistical ranking of a usage of said unit with respect to a usage of other units of said data during said training session.

18. A method for determining an arrangement of data in a memory for efficient operation of a cache, said method comprising:
executing code during a training session;
determining whether a byte of said data is accessed during said training session; and
compiling said code to place said byte in a line of said memory if said byte is accessed during said training session,
wherein said determining evaluates an indicator that is associated with a byte-sized portion of a line of said cache into which said byte is cached,
wherein said indicator indicates whether said byte is accessed during said training session,
wherein said line of said memory is designated to contain, in contiguous locations, a plurality of bytes of said data that are accessed during said training session.

19. A storage media that contains instructions for controlling a processor to, in turn, perform a method for determining an arrangement of data in a memory for efficient operation of a cache, said storage media comprising:
instructions for controlling said processor to determine whether a unit of said data is accessed during an execution of code; and
instructions for controlling said processor to compile said code to place said unit in a line of said memory if said unit is accessed during said execution,
wherein said line of said memory is designated to contain, in contiguous locations, a plurality of units of said data that are accessed during said execution.
